(19) United States
(12) Patent Application Publication
(10) Pub. No.: US 2007/0045355 A1
(43) Pub. Date: Mar. 1, 2007

(54) Bulk container with collapsible support

(76) Inventors: Steven W. Claussen, Benson, MN (US); Robert L. Claussen, Benson, MN (US); Gerald B. Saude, New London, MN (US); Tad J. Boldan, Sunburg, MN (US)

Correspondence Address: MUETING, RAASCH & GEBHARDT, P.A., P.O. BOX 581415, MINNEAPOLIS, MN, 55458, US

(21) Appl. No.: 11/212,107

(22) Filed: Aug. 25, 2005

(51) Int. Cl. G01F 11/28

(52) U.S. Cl. 222/425

(57) ABSTRACT

A transportable bulk container system is described that includes a bulk container and a collapsible support. The bulk container includes an inlet and an outlet. The collapsible support for the bulk container includes a shell that encloses a dispersed support structure that is positioned between the top and bottom portions of the shell. The top portion of the collapsible support is configured to receive the bulk container. The system may further accommodate a measuring container fluidly coupled to the bulk container.

### BACKGROUND

The present invention relates to a support for use with transportable bulk containers, and a system for delivering bulk materials, e.g., reusable bulk containers and bulk container supports for the transportation and storage of bulk materials.

The transportation of large quantities of bulk liquids or solids has traditionally been carried out by tanker trucks or the like, whereas smaller quantities thereof have been shipped or transported in conventional 55-gallon drums. However, use of such drums has a number of problems, such as their weight and their tendency to leak, dent, and corrode. Furthermore, there are significant costs associated with the handling, use, and disposal of 55-gallon drums, and there are situations where amounts greater than 55 gallons, but less than that carried by a tanker truck, are needed.

One area, for example, where various quantities of bulk material are often needed is the agricultural industry. Individual production sites in the agricultural industry (e.g. farms) are more numerous and more geographically dispersed than in other industries, and are often relatively remote from major transport arteries. Furthermore, due to the number of sites and their size, intermediate, but generally not tanker-sized, amounts of materials such as fertilizer and crop protection chemicals are often required for each site. Distribution channels for the agricultural industry have evolved to deal with this geographical dispersion through use of a number of intermediaries, and generally there is at least one step in the distribution channel between the original supplier and the agricultural site. This leads to the need to be able to safely transport bulk materials where loading, unloading, and temporary storage may occur repeatedly before delivery and use at a final site.

When bulk material is potentially hazardous, as may be the case for fertilizers or crop protection chemicals, repeated handling of the bulk containers can increase the risk of damage to the containers and potential spills. As most crop protection chemicals have a high price/volume ratio and many may be potentially hazardous if spilled or leaked, container integrity is very important.

Increasingly, volumes of bulk materials such as those used in agriculture are being purchased by end-users in large refillable containers sometimes referred to as shuttles. Many of these shuttles may be more formally referred to as intermediate bulk containers (IBC). Requirements for these types of containers are outlined in various D.O.T. and F.D.A. regulations, and are specifically described in 49 CFR Section 178. IBCs include numerous types of designs, including metal IBCs (i.e., those constructed of metal), rigid plastic IBCs (i.e., those constructed of all-plastic material), and composite IBCs (i.e., those that include a rigid outer package enclosing a plastic inner receptacle). IBCs typically have a capacity in the range of 250-550 gallons. As such, they are a useful alternative to 55-gallon drums.

IBCs typically have an integral pump or connector for an external pump to permit transfer of liquid, and are commonly shipped on a pallet and handled by a forklift. An example of a shuttle used in the agriculture industry is the Chem-Fer™ bulk handling system, available from Redball, LLC (Benson, Minn.). One embodiment of the Chem-Fer™ bulk handling system provides a 150 gallon tank that is suspended on a metal frame, which then delivers material to a 5-10 gallon measuring vessel for mixing into carrier liquid for delivery, typically at an agricultural site.

While a great deal of progress has been made in providing bulk material containers, particularly those suited for intermediate sized amounts of material, many of these containers are still awkward to deliver, and may require assembly onto a support before they can be used at the final site. Further, many bulk material containers may not be sufficiently protected to reliably prevent leakage or spills during transportation.

Accordingly, there is a need for improved bulk containers and supports that can be safely and reliably transported and reused.

### SUMMARY OF THE INVENTION

The present invention provides a bulk container and support system and methods of use that can be used to safely and reliably transport bulk material. In one aspect, the present invention provides a transportable bulk container system that includes a collapsible support. The collapsible support includes a shell, wherein the shell includes at least a support top portion, a support bottom portion, and at least one side wall extending between the support top portion and support bottom portion. The collapsible support further includes a dispersed support structure positioned between the support top portion and support bottom portion. The transportable bulk container system also includes a bulk container. The bulk container includes a bulk container inlet and a bulk container outlet. The support top portion of the collapsible support is configured to receive the bulk container thereon. In one embodiment of the bulk container system, the collapsible support includes plastic in its construction.

In an additional embodiment, the bulk container system includes a measuring container in fluid communication with the bulk container outlet. The measuring container may be connected to the bulk container outlet by a conduit that includes a flexible region. The bulk container may also be in communication with the measuring container using a vent line. In further embodiments, the measuring container is positioned within a recess defined by at least one side wall of the collapsible support. The measuring container may have a capacity of 1 to 25 gallons.

In yet an additional embodiment of the bulk container system, the bulk container has a capacity of 50 to 500 gallons. In a further embodiment, a bottom portion of the bulk container is configured to mate with the support top portion of the collapsible support. This embodiment may also include a plurality of support shoulders positioned at one or more corners of the collapsible support that mate with one or more indentations defined at one or more corners of the bottom portion of the bulk container. In a further embodiment, the support bottom portion of the collapsible support contains two or more aligned lift channels.

In an additional embodiment of the bulk container system, the dispersed support structure includes a plurality of support pillars that extend from the support top portion of the collapsible support to the support bottom portion of the collapsible support.

In another aspect, the present invention provides a method for delivering bulk material that includes providing a bulk container for receiving a bulk material, and resting the bulk container on a top portion of a collapsible support formed in part from plastic, wherein the collapsible support includes a dispersed support structure within a shell for support of the bulk container thereon. In one embodiment of the method, the bulk container has a capacity of 50 to 500 gallons.

In another embodiment, the method also includes transferring a measured portion of bulk material received in the bulk container to a measuring container supported by the collapsible support. The measuring container may have a capacity of 1 to 25 gallons. The method may also include resting the bulk container on the top portion of the collapsible support by mating a bottom portion of the bulk container to the top portion of the collapsible support.

In yet another aspect, the present invention provides a collapsible support for a bulk material container that includes a shell formed of plastic, wherein the shell includes at least a top portion, a bottom portion, and at least one side wall extending between the top and bottom portion. The shell also includes a dispersed support structure positioned between the top and bottom portions. In one embodiment, the dispersed support structure includes a plurality of plastic support pillars that extend from the top to the bottom of the shell. In another embodiment, the collapsible support includes a recess for receiving a measuring container in at least one side wall of the collapsible support.

In a further embodiment of the collapsible support, the top portion of the shell is configured to mate with a bulk material container. In a further embodiment, the bottom of the collapsible support defines two or more aligned lift channels. In an embodiment of the collapsible support that includes aligned lift channels, the dispersed support structure may include one or more support pillars extending from the top to the bottom of the shell positioned within each aligned lift channel.

In yet another embodiment of the collapsible support, the collapsible support protects the integrity of a bulk material container supported by the collapsible support when the bulk material container is dropped 6 feet or less when the bulk material container is loaded with a bulk material with a specific gravity of about 1.0.

### BRIEF DESCRIPTION OF THE FIGURES

FIG. 1 is a perspective view of an exemplary embodiment of the transportable bulk container system of the present invention.

FIG. 2 is a rear view of the transportable bulk container system shown in FIG. 1.

FIG. 3 is a front view of the transportable bulk container system shown in FIG. 1.

FIG. 4 is a bottom view of the transportable bulk container system shown in FIG. 1.

FIG. 5 is a cross-section at line 5-5 of the transportable bulk container system shown in FIG. 3.

FIG. 6 is an enlarged cross-section of a portion of the exemplary embodiment of the present invention shown in FIG. 5, illustrating conduits as shown in FIG. 5 connected to an alternate measuring container usable in the system.

FIG. 7 is a perspective view of an exemplary embodiment of a collapsible support used in the system shown in FIGS. 1-7.

FIG. 8 is a cross-section view at line 8-8 as shown in FIG. 4 of the collapsible support shown in FIG. 7.

### DETAILED DESCRIPTION OF EMBODIMENTS OF THE INVENTION

The following discussion is presented to enable a person skilled in the art to make and use the invention. Various modifications will be readily apparent to those skilled in the art, and the general principles disclosed herein may be applied to other embodiments and applications without departing from the scope of the present invention as defined by the appended claims. Thus, the present invention is not intended to be limited to the embodiments shown, but is to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of the invention. Skilled artisans will recognize the embodiments provided herein have many useful alternatives that fall within the scope of the invention.

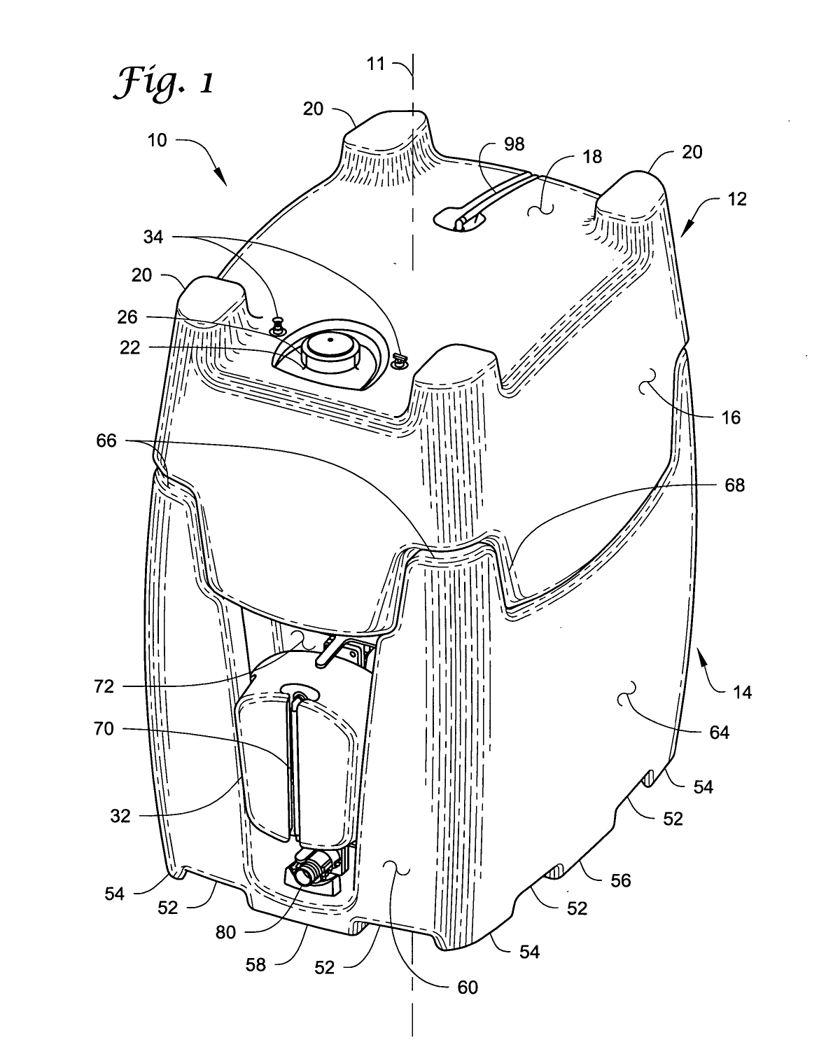

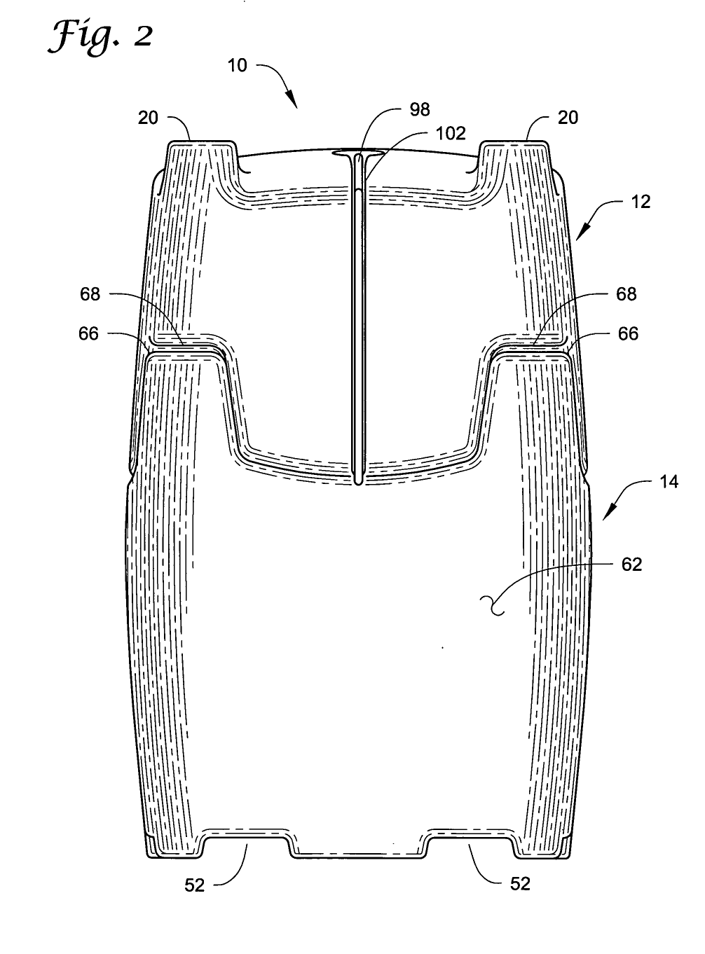

Referring to FIGS. 1-5, an exemplary embodiment of a transportable bulk container system 10 of the present invention is shown. The bulk container system 10 includes a bulk container 12 and a collapsible support 14 that extends along axis 11. A bulk container 12 is a vessel designed to carry bulk material, preferably without significant loss of bulk material due, for example, to spillage or leakage. The bulk container system 10 may further include a measuring container 32 fluidly coupled to the bulk container 12.

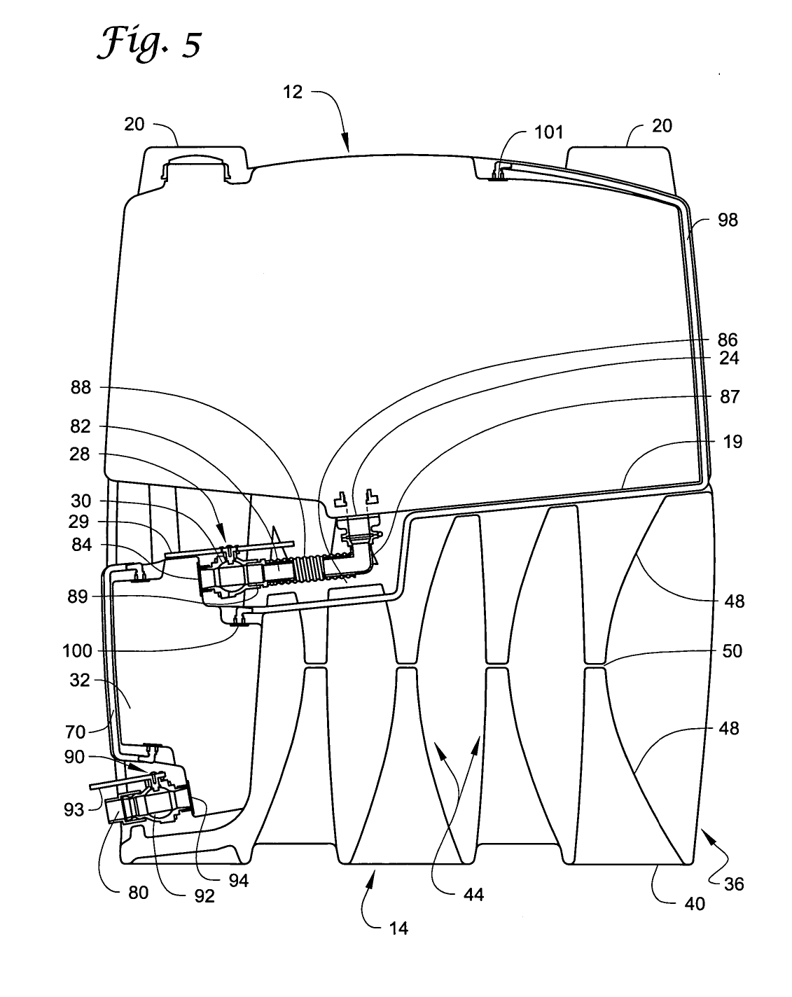

The bulk container 12 has one or more container sides 16, as well as a container top 18 and a container bottom 19 (see FIG. 5). Top 18 and bottom 19, as defined herein, are not intended to refer to only the uppermost (or lowest) point of an object, but rather refer to a portion of one or more surfaces that includes the top (or bottom, upon which the object normally rests) of an object. The bulk container 12 can have a variety of shapes; for example, it may be generally spherical, pyramidal, or cylindrical. In one embodiment, the bulk container 12 may be generally cubical in shape.

Shapes that may be readily stacked to facilitate transportation of multiple bulk containers 12 are preferred. To facilitate stacking of multiple bulk containers 12 during shipping, the bulk container 12 may also include one or more stacking projections 20. Stacking projections 20 are raised portions along the container top 18 that are shaped and positioned such that they fit with correspondingly shaped and positioned indentations 68 on the container bottom. Stacking projections 20 thus serve to retain stacked bulk containers 12 in place by preventing, for example, lateral motion of the containers with respect to each other when stacked or when positioned on a mating support.

The bulk container 12 of the bulk container system 10 is designed to carry bulk material. In addition, the bulk container system 10 must be able to receive and release bulk material. Accordingly, the bulk container 12 includes a bulk container inlet 22 and a bulk container outlet 24 (see FIG. 5). Inlets and outlets, as used herein, are openings within a surface of a vessel that are intended for input and output of bulk material, respectively. Embodiments of the bulk container 12 provide the bulk container inlet 22 on the container top 18 to facilitate transfer and retention of contained bulk material by gravity. The bulk container inlet 22 may be sealed by a cap 26. The cap 26 and the bulk container inlet 22 may be threaded to allow the cap to be twisted on and off, or the cap 26 may be secured to the bulk container inlet 22 by other methods known to those skilled in the art (e.g., snap caps).

The bulk container outlet 24 can be more readily seen in FIG. 5. The bulk container outlet 24 may be positioned at the container bottom 19 to facilitate egress of released bulk material by gravity. The bulk container outlet 24 may be controlled by release control apparatus 28. The release control apparatus 28 includes a release valve 30 that can open and shut to control flow through the bulk container outlet 24. In the embodiment shown, the release control apparatus 28 includes a bulk container manual control 29 (e.g., a pivoting handle) that can be turned to control the release valve 30. While the embodiment shown in FIG. 5 portrays a bulk container outlet 24 that releases bulk material to a measuring container 30, other embodiments of the invention may release bulk material directly from the bulk container outlet 24 without passing through a measuring container 32. Further, in some embodiments, flow of bulk material through the bulk container outlet 24 may be driven by a pump.

Bulk material, as defined herein, is a material present in a large quantity. Bulk material is generally present in a sufficiently large quantity so as to preclude the material being carried by an individual without machine assistance, unless the material is particularly lightweight. Accordingly, one or more embodiments of the bulk material container 12 may have a capacity of 50 to 500 gallons, with further embodiments directed to capacities of 100 to 300 gallons. Preferably, the bulk material is a liquid or granular solid that may be poured. The increased reliability provided by the collapsible support 14, described herein, helps make the bulk container 12 particularly well-suited to carry potentially hazardous bulk material such as fuel, fertilizer, and crop protection chemicals. Embodiments of the bulk container 12 may also include one or more pressure valves 34 to prevent the build up of pressure within the bulk container 12, which is particularly useful when handling volatile bulk material.

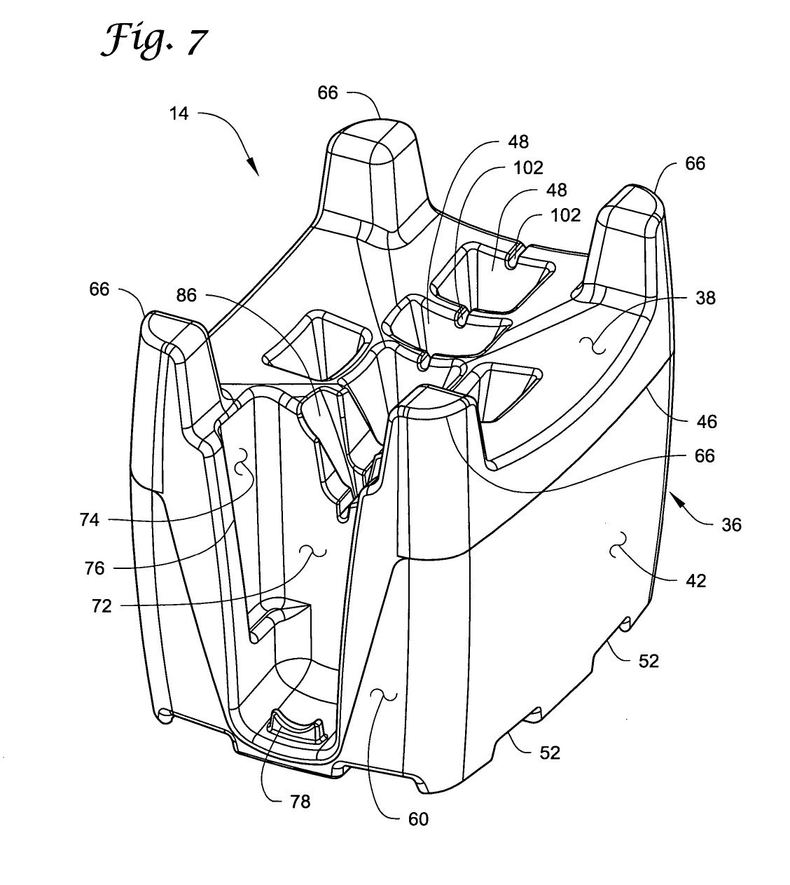

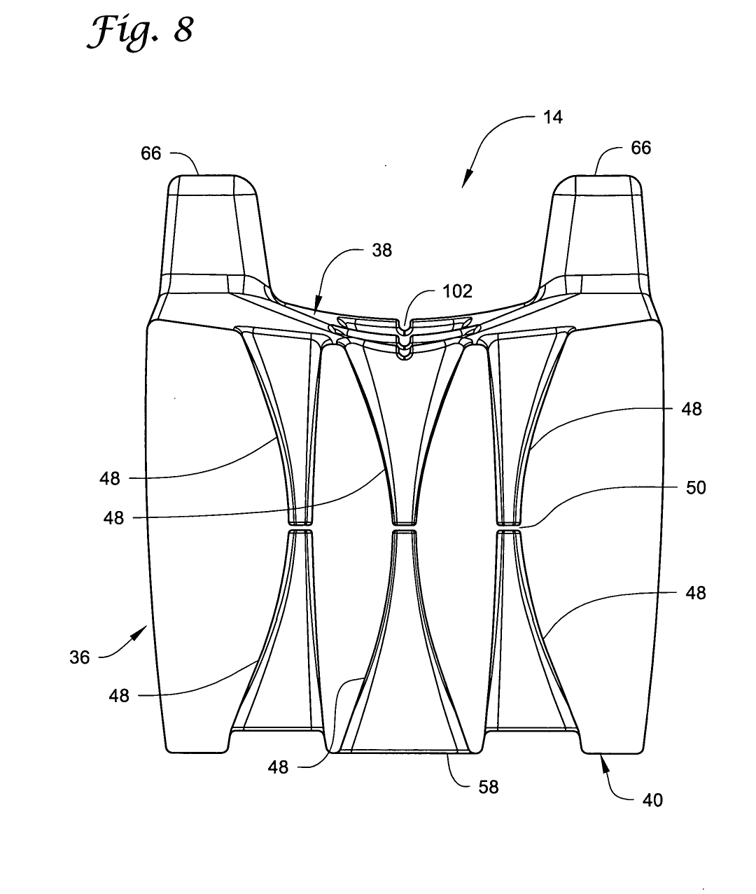

The collapsible support 14 is configured to receive the bulk container 12 thereon. A perspective view of the collapsible support 14 is shown in FIG. 7 and FIG. 8 without the bulk container 12. The collapsible support 14 includes a shell 36 that includes one or more outer surfaces of the collapsible support 14. The shell 36 includes a support top 38, a support bottom 40, and at least one support side wall 42 extending between the support top 38 and the support bottom 40.

The collapsible support 14 may have a variety of shapes, but the shape of the support top 38 preferably conforms to the bottom 19 of the bulk container 12 to provide even and balanced support of the bulk container 12. For example, for a bulk container 12 with a rectangular configuration orthogonal to axis 11, such as shown in the figures, the collapsible support 14 preferably has a similar rectangular configuration orthogonal to axis 11.

The collapsible support 14 includes material within the shell 36 that provides support for the bulk container 12 in a collapsible manner. The collapsible support 14 provides the advantage of being able to bear the weight of the bulk container 12 under normal handling conditions, but can collapse if the bulk container system 10 is subject to a significant impact, which may occur if a loaded bulk container system 10 is dropped. For example, a significant impact to the bulk container system 10 could occur if the bulk container system 10 were to slip off of a forklift, or drop off the back of a truck while loaded with bulk material. For example, an embodiment of the collapsible support 14 will protect the bulk container when dropped 6 feet when the bulk container 12 is loaded with a bulk material having a specific gravity of about 1.0 at a temperature of 0° F., or when dropped 5 feet when the bulk container 12 is loaded with bulk material with a specific gravity of greater than 1.2 at 0° F., as described by the department of transportation test under 49 CFR 178.810 group I.

Collapse of the collapsible support 14 absorbs a portion of the energy of the impact through deformation of at least a portion of its structure, protecting the contents and the integrity of the bulk container 12. Accordingly, collapsible, as defined herein, refers to the ability of the structure to absorb a portion of a significant impact to the structure, through deformation of at least a portion of its structure. While what constitutes a significant impact will vary considerably depending on a number of variables such as the size and density of the bulk material being carried and the speed of the impact, a significant impact will generally result if the bulk carrier system 10 loaded with bulk material is dropped more than one foot.

A variety structures can be used within the shell of the collapsible support 14 to support the weight of the bulk container and help absorb the shock of a significant impact. Further, the shell and structures within can be formed using a variety of materials. For example, the collapsible support 12 may be made of plastic. Plastics are well-suited for use in the collapsible support 14 as plastics can be readily found that provide sufficient support for a bulk container and yet can deform to absorb a significant impact. Plastics are also well-suited as they are relatively lightweight, can be easily manufactured, and are relatively inexpensive. Examples of plastics that may be used include polyurethane, low density hexene copolymer, and related materials. In one embodiment, the plastic used to make the collapsible support has a flexural modulus in the range of about 50,000 to 100,000 p.s.i. (ASTM method D 790), a flexural modulus in the range of about 1,000 to about 5,000 p.s.i. (ASTM Method D 638), and an impact strength in the range of about 100 to 500 ft-lb (ARM) for a collapsible support with a thickness of 0.25 inches.

The collapsible support 14 may be formed, for example, by rotational molding or reaction injection molding (RIM). In a typical RIM process, two reactant streams are combined in a mixhead and then injected into a mold in which polymerization occurs. When formed, the collapsible support 14 may often be manufactured in at least two separate parts that are then assembled together. For example, in FIG. 1, collapsible support 14 is assembled from two parts along a mold line 46 by a “tongue and groove” assembly process.

The thickness of the shell and portions of the support structure 44 will depend on the particular plastic from which it is molded and the size of the collapsible support 14. Generally, however, the shell 36 will have a thickness within the range of about ⅜ to about ⅝ inches, and the thickness of the elements forming the support structure within the shell 36 will be within the range of about ⅛ to about ⅜ inches.

Embodiments of the collapsible support 14 include a dispersed support structure 44 positioned between the support top 38 and the support bottom 40 that includes a plurality of dispersed elements (e.g., pillars 48). Positioning the dispersed support structure 44 between the support top 38 and the support bottom 40 enhances the ability of the collapsible support 14 to bear the bulk container 12, and provides additional structure that can absorb a significant impact. In a further embodiment, portions of the support structure 44 extend from the support top 38 to the support bottom 40 to form support struts. The support struts may be continuous, or they may contain gaps that compress to form a strut when force is applied along axis 11.

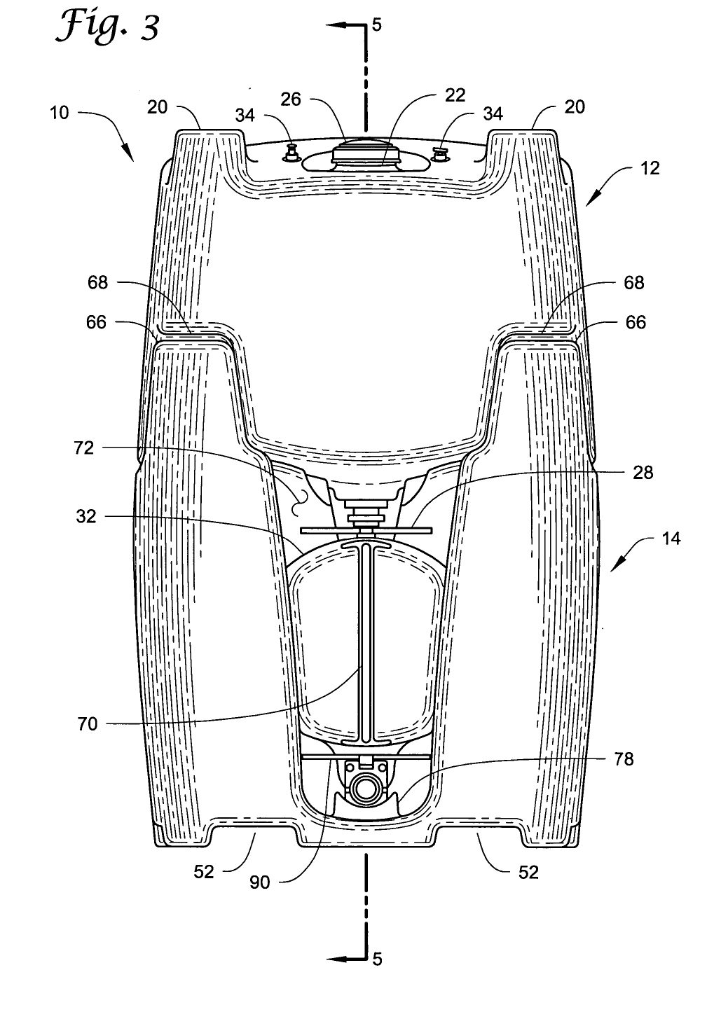

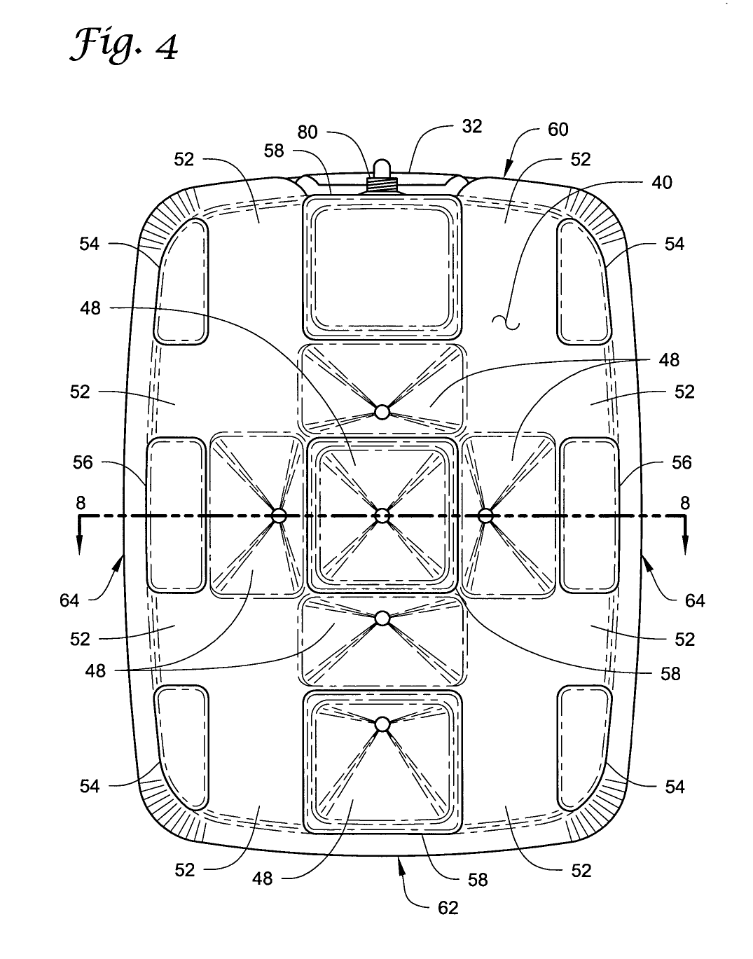

One embodiment of the dispersed support structure 44 is shown in FIG. 5, which provides a cross-section view of the transportable bulk container system 10 along line 5-5 of FIG. 3, and FIG. 8, which provides a cross-section front view of the collapsible support 14 taken along line 8-8 of FIG. 4. In this embodiment, the dispersed support structure 44 includes one or more support struts in the form of support pillars 48. The support pillars 48 are columns that run from the support top 38 to the support bottom 40. The support pillars 48 may contact the support top 38 and/or the support bottom 40, or they may simply be suspended between them. The support pillars 48 may be rectangular, cylindrical, pyramidal, or other shapes that might be used by one skilled in the art. The support pillars 48 may be formed of plastic, or other materials such as wood or metal may be used. Further, the dispersed support structure may be formed using a variety of structures, such as a honeycomb structure or packed particles (e.g., peanut shaped foamed plastic elements).

In the embodiment shown, the support pillars 48 are formed from two pyramidal cones, one extending downwards from the support top 38 and the other extending upwards from the support bottom 40. A small gap 50 may be present at the point where the two halves of the support pillars 48 meet (e.g., due to manufacturing the support in two parts). The use of pyramidal cones to form the support pillars 48 provides a shape with advantages as a collapsible support structure, as they tend to collapse in a measured fashion in response to impacts of increasing size. A pyramidal shape is also less prone to simply shear or fracture in response to a significant impact. Further, the tapered shape of the support assists in separation of the molded parts during manufacturing.

As can be seen most readily in FIG. 4, which provides a bottom view of the transportable bulk container system 10, the collapsible support 14 may also include two or more aligned lift channels 52. Aligned lift channels 52 are channels defined by the outer surface of the support bottom 40 that are configured to receive a forklift's tines to facilitate handling of the bulk container system 10 by a forklift. The lift channels should be aligned in a generally parallel fashion to accommodate entry by parallel forklift tines, and should be positioned such that weight will be evenly distributed on the forklift tines that are fitted into the lift channels 52. For a generally symmetrical bulk container system 10, this generally means that the aligned lift channels 52 will be parallel and equidistant from the center of the support bottom 40. The lift channels should have a size, depth, and spacing appropriate to allow entry of a forklift's tines when the bulk container system is resting on a flat surface.

In some embodiments, two aligned lift channels 52 are provided to permit two-way entry of a forklift's tines. By two-way entry, it is meant that the forklift tines can enter the aligned lift channels 52 from two different sides of the bulk container system 10. In a further embodiment, as shown in FIG. 4, two sets of two aligned lift channels 52 may be provided to allow four-way entry of a forklift's tines; e.g., from the front, back, and either side of the bulk container system 10. While two- and four-way entry are well-suited for a generally rectangular bulk container system 10, as shown in the figures, other arrangements may be better suited for bulk container systems with other shapes.

The lift channels 52 divide the support bottom 40 into various sections that support the bulk container system 10 when it is not being held by a forklift. For the embodiment shown in FIG. 4, these include a corner foot 54 at each corner of the support bottom 40, as well as a side foot 56 at either side of the support bottom 40. One or more of the support pillars 48 also may extend downward to form the sides of the aligned lift channels 52 in the form of one or more pillar foot 58.

The dispersed nature of the support pillars 48 making up the dispersed support structure 44 can be readily seen in the embodiment shown in FIG. 4. For example, in this embodiment, six support pillars are provided; four running from support front 60 to support back 62, with two others placed near the middle of support sides 64, each adjacent to a side foot 56 The support pillars 48 are thus dispersed (e.g., spaced apart) to provide support at a number of different locations within the collapsible support 14.

Embodiments of the dispersed support structure provide support fairly evenly throughout the collapsible support 14. For example, in the embodiment shown, support is provided by a support pillar 48 positioned within the middle of each of the aligned lift channels, with an additional support pillar 48 positioned in the center of the support bottom 40 (e.g., along axis 11) and an additional support pillar provided at the support back 62. Embodiments of the invention may provide support pillars 48 that are symmetrically disposed to form a dispersed support structure 44, as can be readily envisioned for the embodiment shown in FIG. 4 by placement of an additional support pillar 48 at the support front 60 in the absence of a measuring container 32.

The top support 38 portion of the collapsible support 14 is configured to receive the bulk container 12 thereon to form the bulk container system 10. Being configured to receive the bulk container 12, as used herein, indicates that the top support 38 provides a surface upon which the bulk container 12 may be placed where it will remain at rest.

In one embodiment of the invention, the support top 38 of the collapsible support 14 is configured to mate with bottom portion 19 of the bulk container 12. Mating, as referred to herein, refers to a relatively more secure fit between the bulk container 12 and the collapsible support 14 such that lateral movement of the bulk container 12 relative to the collapsible support 14 is inhibited.

For example, in the embodiment shown in FIGS. 1-5, the collapsible support 14 includes support shoulders 66 that inhibit the lateral movement of the bulk container 12 relative to the bulk container 12 when the bulk container 12 is resting on the collapsible support 14. In the embodiment shown, a support shoulder 66 is provided at each corner of the collapsible support 14. The bulk container 12 further includes indentations 68 that have a shape complementary and receptive to the support shoulder 66. A mated fit between the bulk container 12 and the collapsible support 14 is also provided by using a convex surface on the bottom portion 19 of the bulk container 12 that fits smoothly with the concave surface of support top 38 of the collapsible support 14, as can be readily seen in the embodiment shown in FIG. 7.

The bulk container system 10 may also include the measuring container 32, as can be seen in FIG. 1. Measuring container 32 includes an inlet 84 and an outlet 94. A measuring container 32 facilitates removal of a measured amount of the bulk material from within the bulk container 12. The measuring container 32 can also function as an intermediate source of bulk material to prevent contamination of the bulk material in the bulk container 12. Generally, the measuring container 32 is significantly smaller than the bulk container 12 itself. For example, in one embodiment, the measuring container 32 has a capacity in the range of 1 to 25 gallons. The measuring container 32 may be sized to deliver a particular amount of bulk material when allowed to fill.

The measuring container 32 may also be provided with measuring gauge 70. A measuring gauge 70 provides information on the volume of bulk material held within the measuring container 32. For example, in the embodiment shown in the figures, the measuring gauge 70 is a transparent or partially transparent tube that runs along the front of the measuring container 32 that includes graduated markings and is fluidly coupled to the inner surface of the measuring container 32. By matching the level of visible bulk material with markings provided on the measuring gauge 70, the amount of bulk material contained within the measuring container 32 can be determined.

The measuring container 32 may be held within a recess 72 in the collapsible support 14. An embodiment of the recess 72 is most readily viewed in FIG. 1, FIG. 3, and FIG. 7. Placement of the measuring container 32 in the recess 72 provides a number of advantages, such as protecting the measuring container 32 and allowing it to be easily fed with bulk material from the bulk container 12 using gravity. The recess 72 may be defined by one of the side walls (e.g., the support front 60) of the collapsible support 14.

In the embodiment shown in the figures, the recess 72 is positioned in the support front 60. The recess 72 is an indentation in the collapsible support that is generally sized to receive the measuring container 32. In the embodiment shown, the recess 72 includes a groove 74 on each side behind an overlap 76. The overlap 76 covers a portion of the measuring container 32 that fits within the groove 74, retaining the measuring container 32 in place within the recess 72. The recess 72 may also include a container outlet support 78. The container outlet support 78 is a raised portion within the recess 72 upon which outlet line 80, which is fluidly coupled to the measuring container 32, can rest. The measuring container 32 may be fixed within the recess 72, or the measuring container 32 may be removable. In one embodiment, the measuring container 32 is removed by removing the bulk container 12 and sliding the measuing container 32 up and out of groove 74. In another embodiment, the measuring container 32 may be removed with the bulk container 12 remaining in place.

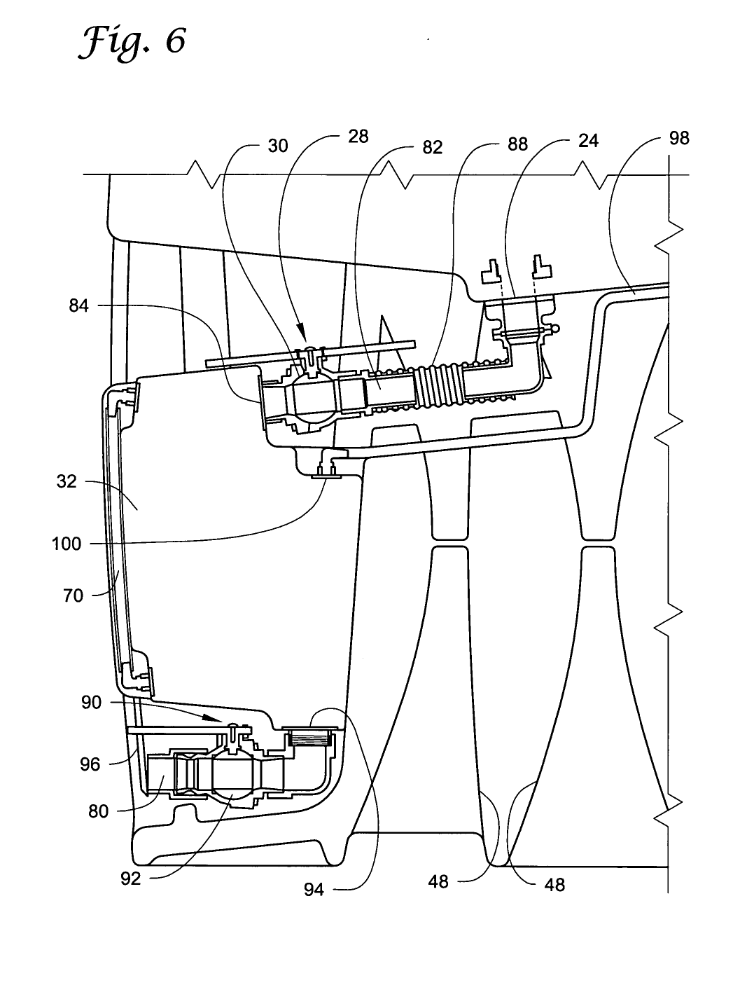

The measuring container 32 is in fluid communication with the bulk container outlet 24 such that bulk material held within the bulk container 12 can flow to the measuring container 32. The flow of material from the bulk container 12 to the measuring container 32, and then outwards through the outlet line 80, can be envisioned most readily from FIG. 5 and FIG. 6, which show cross-section views of different embodiments of the invention.

Flow of material from the bulk container 12 to the measuring container 32 may occur through a conduit, referred to herein as a transfer line 82. The transfer line 82 is preferably a leak-proof vessel, such as a hose, that is connected at one end to the bulk container outlet 24 and at the other end to the measuring container inlet 84. The measuring container inlet 84 is generally positioned on the upper portion of the measuring container 32. The collapsible support 14 may include a transfer channel 86 adjacent to the recess 72 that provides space within the collapsible support 14 for receiving the transfer line 82. To reduce stress on the transfer line 82 that may occur as a result of motion of either the bulk container 12 and/or the measuring container 32, the transfer line 82 may include a flexible region 88, which is a portion of the transfer line 82 that is designed to be more flexible, allowing the transfer line 72 to bend more readily in response to movement. Flexible region 88 may be connected to the more rigid sections 87 and 89, which in turn connect to the bulk container outlet 24 and the inlet 84.

The transfer line 82 may include the release control apparatus 28 that includes release valve 30 to control flow through the transfer line 82 from the bulk container outlet 24 and bulk container manual control 29 (e.g., a handle) that can be turned to control the release valve 30. As the measuring container 32 is generally positioned within the recess 72, the bulk container manual control 29 is generally directly accessible by hand.

While the release control apparatus 28 controls the flow of bulk material from the bulk container 12 to the measuring container 32, an additional control, referred to herein as the measuring container outlet control 90, controls flow of bulk material from the measuring container 32. The measuring container outlet control apparatus 90 includes an outlet valve 92 positioned within the outlet line 80 to control flow through the outlet line 80 upon operation of a measuring container manual control 93 (e.g., a handle). When the measuring container manual control 93 is moved to open the outlet valve 92 and the measuring container 32 includes bulk material, bulk material will flow from the measuring container outlet 94 into the outlet line 80 and then to the outside (e.g., a hose, container, etc.). Again, in the embodiment shown, measuring container manual control 93 can be reached by hand within the recess 72. As shown in FIG. 6, additional embodiments of the invention may include an outlet door 96 to cover and protect the outlet line 80 when it is not in use.

Further, as shown in FIG. 6, the measuring container 32 and inlet 84 and outlet 94 may have one or more different configurations. The inlet 84 and the outlet 94 of the measuring container 32, as well as the bulk container outlet 24, may be coupled to the transfer line 82 and the outlet line 80 by any known manner. For example, valves with hose barbs molded into the valve body may be used. In a further example, lines may be coupled to the outlets using Polypro® hose barb fittings.

In one or more embodiments, the bulk container system 10 includes a vent line 98. The vent line 98 connects a vent opening 101 on the bulk container 12 to a vent opening 100 on the measuring container 32 such that the two are in fluid communication. The vent line 98 serves to equalize the pressure between the bulk container 12 and the measuring container 32 during flow of bulk material through the transfer line 82 and/or during flow through the outlet line 80. In its role as a pressure equalizer, the vent line 98 generally transfers a gas (e.g., air) that is present in the upper portions of the bulk container 12 and the measuring container 32. To allow air transfer rather than the transfer of bulk material, the vent openings 100 and 101 are generally positioned in an upper portion of the bulk container 12 and measuring container 32. The collapsible support 14 may contain vent channels 102 along the support top 38 to provide room for and guide the vent line 98 along the support top 38. A further vent channel 102 may also be defined in a side of the bulk container 12 (e.g., the rear surface) where the vent line 98 travels across the bulk container 12 to reach an upper portion of the bulk container 12 such as the container top 18.

The bulk container system 10 may be used for delivering bulk material. The method of delivering bulk material includes providing a bulk container 12 that contains bulk material. Bulk material may be transferred into the bulk container 12 by opening the bulk container inlet 22 by removing the cap 26. Bulk material is then poured into the bulk material container 12, which may then be closed by re-securing the cap 26 onto the bulk container inlet 22. The bulk material may be transferred into the bulk container 12 while the bulk container 12 is resting on the collapsible support 14 or the bulk container 12 may be loaded onto the collapsible support 14 after it has been filled. The bulk material container 12 and the collapsible support 14 have the characteristics already described herein.

Bulk material may then be delivered by releasing bulk material from the bulk container 12. However, bulk material is generally not delivered immediately; rather, the loaded bulk container system 10 is transported from the site where it has been loaded to a new site. Embodiments of the bulk container system 10 provide for safer delivery and transportation of bulk material by providing a bulk container 12 that does not leak bulk material during transportation and storage of the bulk material. The collapsible support 14 of the bulk container system 10 further reduces the possibility of leakage of bulk material during transportation and storage of bulk material by absorbing impacts delivered to the bulk container system 10, thus protecting the integrity of the bulk container 12. Accordingly, embodiments of the bulk container system 10 are well-suited for the delivery of materials such as fuel, fertilizer, and crop protection chemicals. Depending on the size of the bulk container 12, the bulk container system 10 may be used to deliver bulk material in various amounts. For example, embodiments of the bulk container system 10 may include bulk containers 12 with a capacity of 50 to 500 gallons, thus allowing for the delivery of 50 to 500 gallons of bulk material.

When the bulk container system 10 is at a delivery site, bulk material may be delivered by releasing bulk material from the bulk container 12. Bulk material may be delivered directly from the bulk container 12 by using the release control apparatus 28. Alternately, in embodiments that include a measuring container 32, bulk material may first be transferred to the measuring container 32 using the release control apparatus 28. In embodiments of the invention in which the measuring container 32 includes a measuring gauge 70, the amount of bulk material transferred into the measuring container 32 can be more carefully measured. After a desired quantity of bulk material has been transferred to the measuring container 32, bulk material may be released from the measuring container 32 using the measuring container outlet control apparatus 90. In embodiments of the invention in which the measuring container 32 may be removed, the measuring container 32 may be removed after filling it with a desired amount of bulk material, and the measuring container 32 may be moved to a new site. After moving the measuring container 32 to a new site, bulk material may be delivered from the measuring container 32 using the measuring container outlet control apparatus 90.

Embodiments of the bulk container system 10 may be reused. After delivery of material to one or more sites, as described herein, the bulk container system 10 can be refilled with bulk material and reused. If desired, either the bulk container 12 and/or the measuring container 32 may be cleaned (e.g., by rinsing with a liquid that may include a cleaning agent). Alternately, particularly if the same bulk material is being delivered, the bulk container system 10 can be re-used without cleaning.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modifications as encompassed by the scope of the appended claim.

What is claimed is:

1. A transportable bulk container system, comprising:
a collapsible support comprising a shell, wherein the shell comprises at least a support top portion, a support bottom portion, and at least one side wall extending between the support top portion and support bottom portion, and further wherein the collapsible support comprises a dispersed support structure positioned between the support top portion and support bottom portion; and
a bulk container comprising a bulk container inlet and a bulk container outlet, wherein the support top portion of the collapsible support is configured to receive the bulk container thereon.

2. The system of claim 1, wherein the collapsible support comprises plastic.

3. The system of claim 1, further comprising a measuring container in fluid communication with the bulk container outlet.

4. The system of claim 3, wherein the measuring container is connected to the bulk container outlet by a conduit comprising a flexible region.

5. The system of claim 3, wherein the bulk container is in communication with the measuring container using a vent line.

6. The system of claim 3, wherein the measuring container is positioned within a recess defined by at least one side wall of the collapsible support.

7. The system of claim 3, wherein the measuring container has a capacity of 1 to 25 gallons.

8. The system of claim 1, wherein the bulk container has a capacity of 50 to 500 gallons.

9. The system of claim 1, wherein a bottom portion of the bulk container is configured to mate with the support top portion of the collapsible support.

10. The system of claim 9, wherein the support top portion of the collapsible support comprises a plurality of support shoulders positioned at one or more corners of the collapsible support that mate with one or more indentations defined at one or more corners of the bottom portion of the bulk container.

11. The system of claim 1, wherein the support bottom portion of the collapsible support contains two or more aligned lift channels.

12. The system of claim 1, wherein the dispersed support structure comprises a plurality of support pillars that extend from the support top portion of the collapsible support to the support bottom portion of the collapsible support.

13. A method for delivering bulk material, comprising:
providing a bulk container for receiving a bulk material; and
resting the bulk container on a top portion of a collapsible support comprising plastic, wherein the collapsible support comprises a dispersed support structure within a shell for support of the bulk container thereon.

14. The method of claim 13, wherein the bulk container has a capacity of 50 to 500 gallons.

15. The method of claim 13, further comprising transferring a measured portion of bulk material received in the bulk container to a measuring container supported by the collapsible support.

16. The method of claim 15, wherein the measuring container has a capacity of 1 to 25 gallons.

17. The method of claim 13, wherein resting the bulk container on the top portion of the collapsible support comprises mating a bottom portion of the bulk container to the top portion of the collapsible support.

18. A collapsible support for a bulk material container, comprising:
a shell formed of plastic, wherein the shell comprises at least a top portion, a bottom portion; and
at least one side wall extending between the top and bottom portion; and
a dispersed support structure positioned between the top and bottom portions.

19. The collapsible support of claim 18, wherein the dispersed support structure comprises a plurality of plastic support pillars that extend from the top to the bottom of the shell.

20. The collapsible support of claim 18, wherein the at least one side wall comprises a recess for receiving a measuring container.

21. The collapsible support of claim 18, wherein the top portion of the shell is configured to mate with a bulk material container.

22. The collapsible support of claim 18, wherein the bottom of the collapsible support defines two or more aligned lift channels.

23. The collapsible support of claim 22, wherein the dispersed support structure comprises one or more support pillars extending from the top to the bottom of the shell positioned within each aligned lift channel.

24. The collapsible support of claim of claim 18, wherein the collapsible support protects the integrity of a bulk material container supported by the collapsible support when the bulk material container is dropped by about 6 feet or less when the bulk material container is loaded with a bulk material with a specific gravity of about 1.0.
